(19) United States
(12) Patent Application Publication
(10) Pub. No.: US 2024/0172893 A1
(43) Pub. Date: May 30, 2024

(54) GRILL LID

(71) Applicant: Lei GAO, Ontario, CA (US)

(72) Inventor: Lei GAO, Ontario, CA (US)

(73) Assignee: JZL International Inc., Ontario, CA (US)

(21) Appl. No.: 18/059,910

(22) Filed: Nov. 29, 2022

(51) Int. Cl. A47J 37/07; E05D 3/12

(52) U.S. Cl. CPC A47J 37/0786; E05D 3/12

(57) ABSTRACT

A grill includes a main body with a main body rear right corner and a main body rear left corner. A lid cover includes a lid cover left sidewall and a lid cover right sidewall. A hinge linkage assembly connects the grill body to the grill lid. The linkage assembly includes a right front hinge link, a right rear hinge link, a left front hinge link, and a left rear hinge link. The right rear hinge link has a right rear hinge link upper joint connected to the lid cover right sidewall, and a right rear hinge link lower joint connected to the main body rear right corner. The left rear hinge link has a left rear hinge link upper joint connected to the lid cover left sidewall, and a left rear hinge link lower joint connected to the main body rear left corner.

### FIELD OF THE INVENTION

The present invention is in the field of grills.

### DISCUSSION OF RELATED ART

A variety of grill lids have been invented with swivel lids.

### SUMMARY OF THE INVENTION

A grill includes a main body with a main body rear right corner and a main body rear left corner. A lid cover includes a lid cover left sidewall and a lid cover right sidewall. A hinge linkage assembly connects the grill body to the grill lid. The linkage assembly includes a right front hinge link, a right rear hinge link, a left front hinge link, and a left rear hinge link. The right rear hinge link has a right rear hinge link upper joint connected to the lid cover right sidewall, and a right rear hinge link lower joint connected to the main body rear right corner. The left rear hinge link has a left rear hinge link upper joint connected to the lid cover left sidewall, and a left rear hinge link lower joint connected to the main body rear left corner.

A right side bracket is connected to the main body rear right corner, and a left side is bracket connected to the main body rear left corner. The hinge linkage assembly is connected to the right side bracket and the left side bracket. The right rear hinge link lower joint and the right front hinge link lower joint are pivotally mounted to the right side bracket. The left rear hinge link lower joint and the left front hinge link lower joint are pivotally mounted to the left side bracket.

The hinge linkage assembly is mounted to the lid cover left sidewall inside surface and the lid cover right sidewall inside surface. The right rear hinge link of the right front hinge link is mounted to the lid cover right sidewall inside surface. The left rear hinge link and the left front hinge link are mounted to the lid cover right sidewall inside surface.

A right side bracket and a left side bracket are externally mounted. The right side bracket is externally mounted to a main body right sidewall, and the left side bracket is externally mounted to a main body left sidewall. The hinge linkage assembly is externally mounted to the right side bracket and externally mounted to the left side bracket.

The left front hinge link is longer than the left rear hinge link, and the right front hinge link is longer than the right rear hinge link. A distance between the left rear hinge link upper joint and the left front hinge link upper joint is greater than a distance between the left rear hinge link lower joint and the left front hinge link lower joint. A distance between the right rear hinge link upper joint and the right front hinge link upper joint is greater than a distance between the right rear hinge link lower joint and the right front hinge link lower joint.

### BRIEF DESCRIPTION OF THE DRAWINGS

FIG. 1 is a left perspective view of the present invention with the cooktop tray removed.

FIG. 2 is a right perspective view showing the lid cover in open position.

FIG. 3 is a right perspective view of the present invention with the cooktop tray removed.

FIG. 4 is a left perspective view showing the lid in open position.

The following call out numbers can be a useful guide in referencing the element numbers of the drawings.
20 Main Body
21 Main Body Rear Right Corner
22 Main Body Rear Left Corner
23 Main Body Right Sidewall
24 Main Body Left Sidewall
26 Main Body Left Sidewall Upper Edge Trim
25 Main Body Right Sidewall Upper Edge Trim
30 Cooktop Tray
31 Cooktop Surface
32 Cooktop Rear Sidewall
33 Cooktop Left Sidewall
34 Cooktop Right Sidewall
35 Cooktop Sidewall Height
40 Hinge Bracket
41 Right Side Bracket
42 Left Side Bracket
43 Right Side Bracket Upper Connection
44 Left Side Bracket Upper Connection
45 Right Side Bracket Lower Connector
46 Left Side Bracket Lower Connector
47 Right Side Bracket Lower Extension
48 Left Side Bracket Lower Extension
51 Right Rear Hinge Link
52 Left Rear Hinge Link
53 Right Front Hinge Link
54 Left Front Hinge Link
55 Right Side Bracket Forward Extension
56 Left Side Bracket Forward Extension
60 Hinge Linkage Assembly
61 Right Rear Hinge Link Lower Joint
67 Right Rear Hinge Link Lower Joint
63 Right Front Hinge Link Lower Joint
65 Right Rear Hinge Link Upper Joint
62 Left Rear Hinge Link Lower Joint
64 Left Front Hinge Link Lower Joint
66 Left Lower Hinge Link Upper Joint
68 Left Rear Hinge Link Upper Joint
81 Lid Cover Top Surface
82 Lid Cover Front Sidewall
83 Lid Cover Left Side Wall
84 Lid Cover Right Side Wall Inside Surface
85 Lid Cover Left Sidewall Inside Surface
87 Lid Offset Gap
88 Front Lid Handle
91 Right Rear Hinge Link Length
92 Right Front Hinge Link Length
93 Left Rear Hinge Link Length
94 Left Front Hinge Link Length
95 Right Table Extension Upper Surface
96 Left Table Extension Upper Surface

### DETAILED DESCRIPTION OF THE PREFERRED EMBODIMENT

As seen in FIGS. 1-4, the grill can be a gas grill or wood fired grill. The grill generally has a main body 20 that contains the burner assembly. The main body 20 has a right table extension 96 and a left table extension 98 and is supported by legs 70. A user can lift the lid cover 80 at the front handle 88 and swivel the lid cover 80 from an open position to a closed position back to an open position and then back to a closed position. The right table extension 97 can be used for storing cooked meats, while the left table extension 98 can be used for storing raw meat freshly marinated and ready to cook.

The main body 20 is preferably formed as panels that include a front panel, a left panel, a right panel, and a rear panel. Thus, the main body has a main body right sidewall 23, and a main body left sidewall 24. The main body 20 is preferably formed of steel. Similarly, the lid cover 80 is also formed of steel and has a lid cover front sidewall 82. The front lid handle 88 is mounted to the lid cover front sidewall 82. The lid cover 80 also has a lid cover top surface 81 that is formed between a lid cover left sidewall 83 and a lid cover right sidewall 84. The lid cover 80 has a lid offset gap 87 such that it floats at a height above the main body 21 when in its closed position.

The lid cover 80 is mounted to the main body 20 at a hinge bracket 40. The hinge bracket 40 is externally mounted to the main body 20 by connectors. The hinge bracket 40 supports a hinge linkage assembly 60.

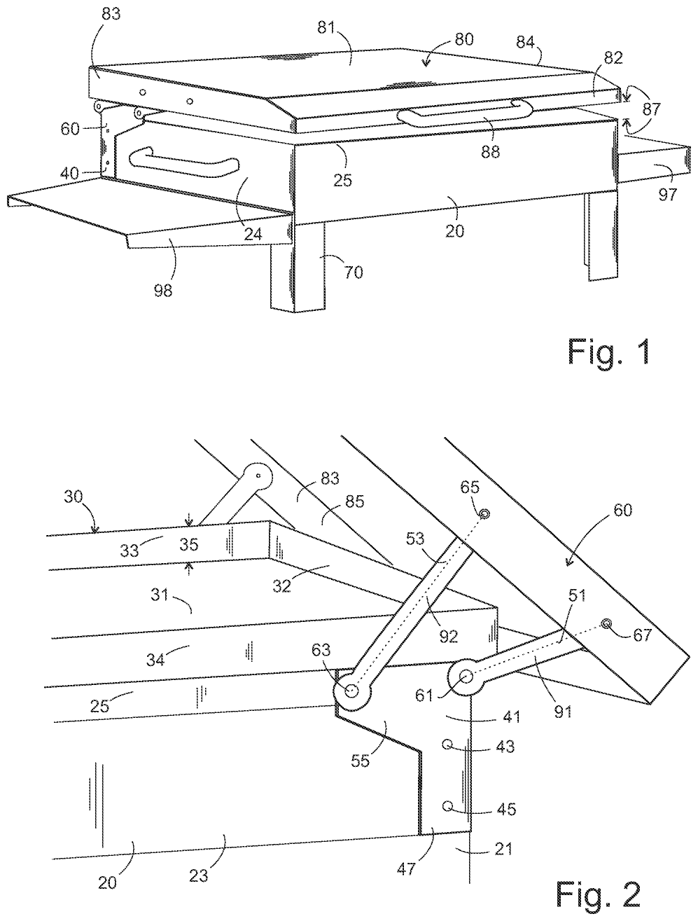

As seen in FIGS. 1-2, the cooktop tray 30 can be mounted over the main body 20. The cooktop tray has a cooktop left sidewall 31 and a cooktop right sidewall 34 with a cooktop rear sidewall 32 bounding a cooktop surface 31. When closed, the lid cover front sidewall 82 covers the cooktop surface 31 and optionally a cooktop front sidewall. The cooktop tray 30 has a cooktop sidewall height 35. The cooktop sidewall height 35 provides an underlap with the lid cover left sidewall 83, the lid cover front sidewall 82, and the lid cover left sidewall 84, while still allowing airflow.

The hinge linkage assembly 60 includes a total of four links, namely a right rear hinge link 51, a right front hinge link 53, a left front hinge link 54, and a left rear hinge link 52. A the right side bracket 41 has the right side bracket lower extension 47 that extends downwardly, and a right side bracket forward extension 55 that extends forwardly from a main body rear right corner 21. The right side bracket lower extension 57 can be connected to the main body right sidewall 23 at a right side bracket lower connector 45 and a right side rocket upper connector 43 such as by screws or rivets.

The side bracket forward extension 55 is at a main body right sidewall upper edge trim 55 of the main body right sidewall 23. The right rear hinge link 51 is mounted to the right side bracket 41 at the right rear hinge link lower joint 61 and is mounted to the lid cover right sidewall 84 at the right rear hinge link upper joint 67. The right front hinge link 53 is mounted to the right side bracket forward extension 55 at the right front hinge link lower joint 63. The right front hinge link 53 is also mounted to the lid cover right sidewall 84 at the right rear hinge link upper joint 65. The right front hinge link 53 has a right front hinge link length 92 that is longer than the right rear hinge link length 91 of the right rear hinge link 51.

The lid cover sidewall inside surfaces such as the lid cover left sidewall inside surface 85 and the lid cover right sidewall inside surface 86 receive the joint connections. The right front hinge link upper joint 65 and the right rear hinge link upper joint 67 are both mounted to the lid cover right sidewall inside surface 86 such that the right front hinge link 53 and the right rear hinge link 51 are pivotally mounted to and parallel to the lid cover right sidewall inside surface 86. The right front hinge link 53 and the right rear hinge link 51 are mounted to an external surface of the right side bracket 41. The main body right sidewall upper edge trim 25 is optionally included to be mounted to an upper edge of the main body right sidewall 23. The main body right sidewall 23 can be formed as a thick gauge steel sidewall. A the main body right sidewall upper edge trim 25 extend over an upper edge of the main body right sidewall 23 to provide structural rigidity.

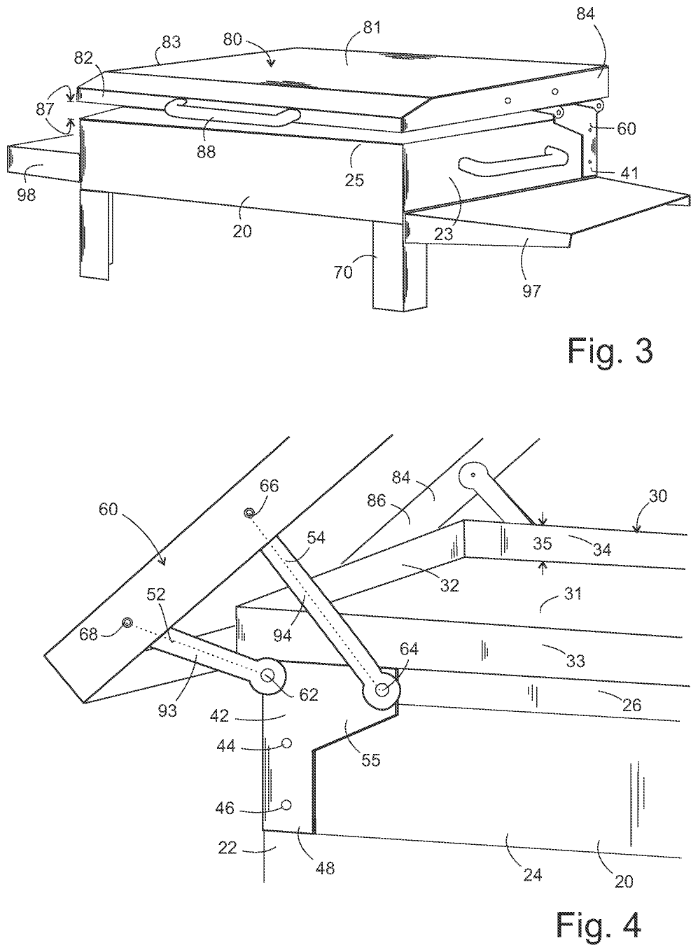

As seen in FIGS. 3-4, the left side bracket 42 can be mounted to the main body 20 at a left bracket upper connector 44 and a left bracket lower connector 46. The side bracket forward extension 56 receives external mounting of pivot joints. The left rear hinge link lower joint 62 and the left front hinge link lower joint 64 are externally mounted to the left side bracket 42 at the left side bracket upper connector 44. Similarly, the main body left sidewall upper edge trim 26 can be formed as an overlap that reinforces and encloses the upper edge of the main body left sidewall 24.

The left rear hinge link length 93 is less than the left front hinge link length 94. The left rear hinge link 52 is mounted behind the left front hinge link 54. The left rear hinge link 52 has a left rear hinge link lower joint 63 that is mounted to the left side bracket 42 near the main body rear left corner 22 and may also be connected to the main body 20 at the main body left sidewall 24. The left rear hinge link 52 has a left rear hinge link upper joint 68 that is pivotally connected to the lid cover left sidewall 83. The left front hinge link upper joint 66 is also totally connected to the lid cover left sidewall 83. The distance between the left rear hinge link upper joint 68 and the left front hinge link upper joint 66 is greater than the distance between the left rear hinge link lower joint 62 and the left front hinge link lower joint 64. This is symmetrical to the right side where the distance between the right rear hinge link upper joint 67 and the right front hinge link upper joint 65 is greater than the distance between the right rear hinge link lower joint 61 and the right front hinge link lower joint 63.

The left front hinge link upper joint 66 is mounted with the left rear hinge link upper joint on the lid cover left sidewall inside surface 85 such that the left rear hinge link 52 and the left front hinge link 54 are parallel to the lid cover left sidewall inside surface 85 and pivotally mounted to the lid cover left sidewall inside surface 85.

The lid cover front sidewall 82 can be beveled so that it rests on the cooktop tray 30. The right side bracket and the left side bracket are preferably and flat along the portion that they connect to the main body left sidewall and the main body right sidewall. Similarly, the main body left sidewall and the main body right sidewall are flat in the preferred embodiment where the grill lid is rectangular. Similarly, the hinge links are flat and fitted between the lid cover side walls and the main body sidewalls.

1. A grill comprising:
a. a main body, wherein the main body has a main body rear right corner and a main body rear left corner;
b. a lid cover, wherein the lid cover includes a lid cover left sidewall and a lid cover right sidewall; and
c. a hinge linkage assembly connecting the grill body to the grill lid, wherein the linkage assembly includes a right front hinge link, a right rear hinge link, a left front hinge link, and a left rear hinge link; wherein the right rear hinge link has a right rear hinge link upper joint connected to the lid cover right sidewall, and a right rear hinge link lower joint connected to the main body rear right corner; wherein the left rear hinge link has a left rear hinge link upper joint connected to the lid cover left sidewall, and a left rear hinge link lower joint connected to the main body rear left corner.

2. The grill of claim 1 further including a right side bracket connected to the main body rear right corner, and a left side bracket connected to the main body rear left corner, wherein the hinge linkage assembly is connected to the right side bracket and the left side bracket, wherein the right rear hinge link lower joint and the right front hinge link lower joint are pivotally mounted to the right side bracket, wherein the left rear hinge link lower joint and the left front hinge link lower joint are pivotally mounted to the left side bracket.

3. The grill of claim 1, wherein the hinge linkage assembly is mounted to the lid cover left sidewall inside surface and the lid cover right sidewall inside surface, wherein the right rear hinge link of the right front hinge link is mounted to the lid cover right sidewall inside surface, and wherein the left rear hinge link of the left front hinge link is mounted to the lid cover right sidewall inside surface.

4. The grill of claim 1, further comprising a right side bracket and a left side bracket, wherein the right side bracket is externally mounted to a main body right sidewall, and wherein the left side bracket is externally mounted to a main body left sidewall, wherein the hinge linkage assembly is externally mounted to the right side bracket and externally mounted to the left side bracket.

5. The grill of claim 1, wherein the left front hinge link is longer than the left rear hinge link, wherein the right front hinge link is longer than the right rear hinge link; wherein a distance between the left rear hinge link upper joint and the left front hinge link upper joint is greater than a distance between the left rear hinge link lower joint and the left front hinge link lower joint; and wherein a distance between the right rear hinge link upper joint and the right front hinge link upper joint is greater than a distance between the right rear hinge link lower joint and the right front hinge link lower joint.

6. The grill of claim 5 further including a right side bracket connected to the main body rear right corner, and a left side bracket connected to the main body rear left corner, wherein the hinge linkage assembly is connected to the right side bracket and the left side bracket, wherein the right rear hinge link lower joint and the right front hinge link lower joint are pivotally mounted to the right side bracket, wherein the left rear hinge link lower joint and the left front hinge link lower joint are pivotally mounted to the left side bracket.

7. The grill of claim 5, wherein the hinge linkage assembly is mounted to the lid cover left sidewall inside surface and the lid cover right sidewall inside surface, wherein the right rear hinge link of the right front hinge link is mounted to the lid cover right sidewall inside surface, and wherein the left rear hinge link of the left front hinge link is mounted to the lid cover right sidewall inside surface.

8. The grill of claim 7, further comprising a right side bracket and a left side bracket, wherein the right side bracket is externally mounted to a main body right sidewall, and wherein the left side bracket is externally mounted to a main body left sidewall, wherein the hinge linkage assembly is externally mounted to the right side bracket and externally mounted to the left side bracket.

9. The grill of claim 7 further including a right side bracket connected to the main body rear right corner, and a left side bracket connected to the main body rear left corner, wherein the hinge linkage assembly is connected to the right side bracket and the left side bracket, wherein the right rear hinge link lower joint and the right front hinge link lower joint are pivotally mounted to the right side bracket, wherein the left rear hinge link lower joint and the left front hinge link lower joint are pivotally mounted to the left side bracket.

10. The grill of claim 9, further comprising a right side bracket and a left side bracket, wherein the right side bracket is externally mounted to a main body right sidewall, and wherein the left side bracket is externally mounted to a main body left sidewall, wherein the hinge linkage assembly is externally mounted to the right side bracket and externally mounted to the left side bracket.
